(19) United States
(12) Patent Application Publication
(10) Pub. No.: US 2015/0016579 A1
(43) Pub. Date: Jan. 15, 2015

(54) CLOCK AND DATA RECOVERY DEVICE, SAMPLER AND SAMPLING METHOD THEREOF

(71) Applicant: REALTEK SEMICONDUCTOR CORPORATION, Hsinchu (TW)

(72) Inventor: Pei-Si WU, Kaohsiung City (TW)

(73) Assignee: REALTEK SEMICONDUCTOR CORPORATION, Hsinchu (TW)

(21) Appl. No.: 14/283,979

(22) Filed: May 21, 2014

(30) Foreign Application Priority Data
Jul. 11, 2013 (TW) 102124841

(51) Int. Cl. H04L 7/00

(52) U.S. Cl. CPC H04L 7/0016
USPC 375/355

(57) ABSTRACT

A clock and data recovery device, a sampler and a sampling method thereof are provided. The sampler includes a phase generation circuit and a first edge sampling circuit electrically connected with the phase generation circuit. The phase generation circuit is configured to generate a plurality of first phases which have different phase values. The first edge sampling circuit is configured to sample a plurality of first edge values of a plurality of bits of a data signal according to the first phases so that the clock and data recovery device determines a clock of the data signal according to the first edge values.

This application claims priority to Taiwan Patent Application No.: 102124841 filed on Jul. 11, 2013, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a clock and data recovery device, a sampler and a sampling method thereof, and more particularly, to a clock and data recovery device, a sampler and a sampling method thereof for edge sampling.

2. Descriptions of the Related Art

With the rapid development of manufacturing technologies over recent years, a breakthrough in the operating speeds of integrated circuits has also followed. Hence, in response to people's demands for high-speed transmissions, manufacturers have gradually adopted high-speed serial transmission systems in place of parallel transmission systems with a low data transmission rate. The high-speed serial transmission systems are also referred to as serializers-deserializers (SERDESs) which transmit serialized data via a high-speed differential pair line instead of a low-speed parallel bus.

In general, because the high-speed serial transmission system has a high data transmission rate, the signal received at the receiving terminal usually consists of asynchronous data. Furthermore, under the limitations of noise interferences and undesirable effects caused by channels such as reflection, diffraction, transmission, inter-symbol interferences (ISIs), crosstalk and etc., the receiving terminal must perform the synchronization of data more accurately to effectively recover the data transmitted by the transmitting terminal.

The receiving terminal of the high-speed serial transmission system usually adopts a source synchronous (SS) interface or a clock data recovery (CDR) interface to synchronize data. The SS and CDR interface differ from each other in their respective ways of implementing a clock. The SS interface adopts one separate clock signal accompanied by data transmission, while the CDR interface has no separate clock signal and adopts an embedded clock in a data stream for transmission. As compared to the SS interface, the design of the CDR interface is more challenging but the CDR interface has the following advantages: it can improve problems such as skew and crosstalk that are actually caused by the clock; reduce the cost of channels; increase the operating speed; elongate the transmission distance, etc.

In general, it is difficult to design the CDR interface because of jitters. The term “jitter” refers to a displacement between the actual data and signal that is expected to appear in an ideal status. Jitters tend to compromise the accuracy of signal synchronization at the receiving terminal and particularly have a great influence on the operation of the CDR interface at the receiving terminal. Jitters may be generally classified into two categories: quantitative and random. Quantitative jitters include inter character interferences, crosstalk, distortion of the work period, periodic jitters, etc., while random jitters are generally by-products caused by the semiconductor thermal effect.

Improving the sampling accuracy of a sampler is an effective way of preventing the CDR interface from being affected by the jitters. Generally, the CDR interfaces all require the use of one sampler configured to sample the received signal. Ideally, if the sampler can accurately sample the desired data from the received signal, then it means that the CDR interface may have a higher jitter tolerance. The jitter tolerance is usually represented by the unit interval (UI) at the receiving terminal. A larger UI means that the receiver can tolerate more jitters.

For the conventional CDR interface, a way of increasing the sampling accuracy is as follows: sampling a plurality of edges of a plurality of bits of a data signal according to a fixed phase, and estimating the edge positions of the bits of the data signal according to the sampling results to determine the clock embedded in the data signal, thereby sampling the desired data from the received signal. However, the aforesaid way is limited to a fixed sampling point (corresponding to the fixed phase), so there is still a great room for improvement in terms of the speed and the accuracy at which the edge positions of the bits of the data signal are estimated.

According to the above descriptions, the influence caused by the jitters on the CDR interface must be overcome to implement a high-speed serial transmission system. Accordingly, an urgent need still exists in the art to increase the sampling accuracy of the sampler to increase the jitter tolerance of the CDR interface.

### SUMMARY OF THE INVENTION

The present invention provides a sampler for use in a clock and data recovery device. The sampler comprises a phase generation circuit and a first edge sampling circuit electrically connected with the phase generation circuit. The phase generation circuit is configured to generate a plurality of first phases which have different phase values. The first edge sampling circuit is configured to sample a plurality of first edge values of a plurality of bits of a data signal according to the first phases so that the clock and data recovery device determines a clock of the data signal according to the first edge values.

The present invention further provides a clock and data recovery device. The clock and data recovery device comprises a sampler and a processor. The sampler comprises a phase generation circuit and a first edge sampling circuit electrically connected with the phase generation circuit. The phase generation circuit is configured to generate a plurality of first phases which have different phase values. The first edge sampling circuit is configured to sample a plurality of first edge values of a plurality of bits of a data signal according to the first phases. The processor is configured to determine a clock of the data signal according to the first edge values.

The present invention also provides a sampling method for use in a clock and data recovery device. The clock and data recovery device comprises a sampler and a processor. The sampler comprises a phase generation circuit and a first edge sampling circuit electrically connected with the phase generation circuit. The sampling method comprises the following steps:

(a) generating a plurality of first phases which have different phase values by the phase generation circuit;

(b) sampling a plurality of first edge values of a plurality of bits of a data signal according to the first phases by the first edge sampling circuit; and

(c) determining a clock of the data signal according to the first edge values by the processor.

According to the above descriptions, the present invention provides a clock and data recovery device, a sampler and a sampling method thereof. Unlike the conventional CDR interface, the clock and data recovery device, the sampler and the sampling method thereof according to the present invention generate a plurality of different phases through phase scanning and sample edges of a plurality of bits of a data signal respectively according to the phases with different phase values.

As the sampling is performed through phase scanning, the sampling point will not be fixed anymore. The edge values sampled from the edges of the bits of the data signal can cover a wider range. Therefore, the edge positions of the bits of the data signal can be estimated more rapidly and more accurately to determine a proper clock embedded in the data signal. Accordingly, the clock and data recovery device, the sampler and the sampling method thereof according to the present invention have effectively improved the sampling accuracy and also increased the jitter tolerance of the receiving terminal.

The detailed technology and preferred embodiments implemented for the present invention are described in the following paragraphs accompanying the appended drawings for persons skilled in the art to well appreciate the features of the claimed invention.

### BRIEF DESCRIPTION OF THE DRAWINGS

FIG. 1A is a schematic view of a clock and data recovery device according to a first embodiment of the present invention;

FIG. 1B is a schematic view illustrating signal sampling by the clock and data recovery device according to the first embodiment of the present invention;

FIG. 2A is a schematic view of a clock and data recovery device according to a second embodiment of the present invention;

FIG. 2B is a schematic view illustrating signal sampling by the clock and data recovery device according to the second embodiment of the present invention;

FIG. 3A is a schematic view of a clock and data recovery device according to a third embodiment of the present invention;

FIG. 3B is a schematic view illustrating signal sampling by the clock and data recovery device according to the third embodiment of the present invention;

FIG. 4A is a schematic view of a clock and data recovery device according to a fourth embodiment of the present invention;

FIG. 4B is a schematic view illustrating signal sampling by the clock and data recovery device according to the fourth embodiment of the present invention; and

FIG. 5 is a flowchart diagram of a sampling method according to a fifth embodiment of the present invention.

### DESCRIPTION OF THE PREFERRED EMBODIMENT

The present invention may be explained with reference to the following embodiments. However, these embodiments are not intended to limit the present invention to any specific environments, applications or implementations described in these embodiments. Therefore, the description of these embodiments is only for purpose of illustration rather than limitation. In the following embodiments and the attached drawings, elements not directly related to the present invention are omitted from depiction. Dimensional relationships among individual elements in the attached drawings are illustrated only for ease of understanding, but not limitation.

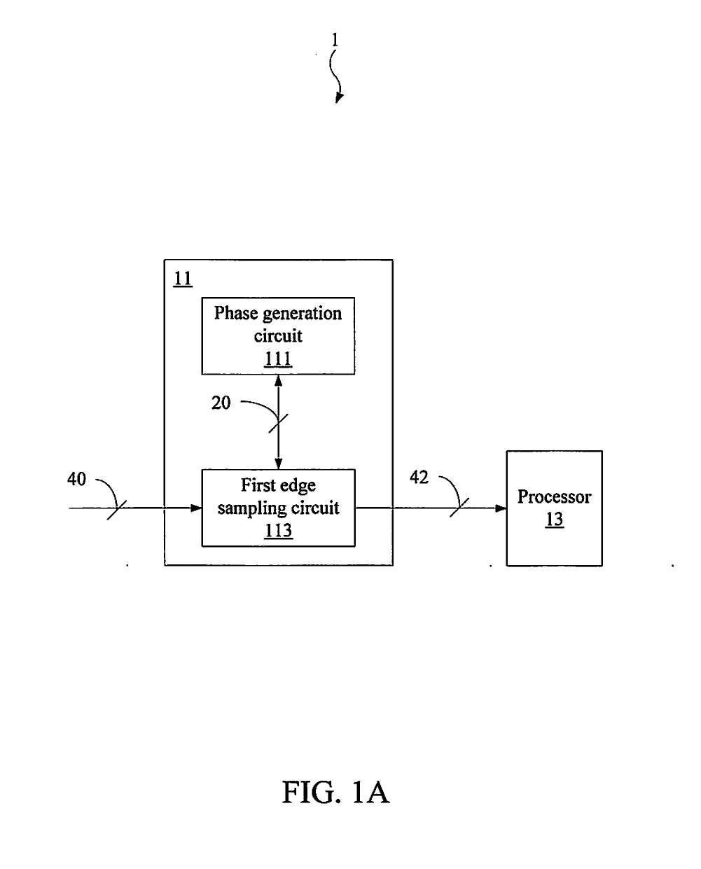

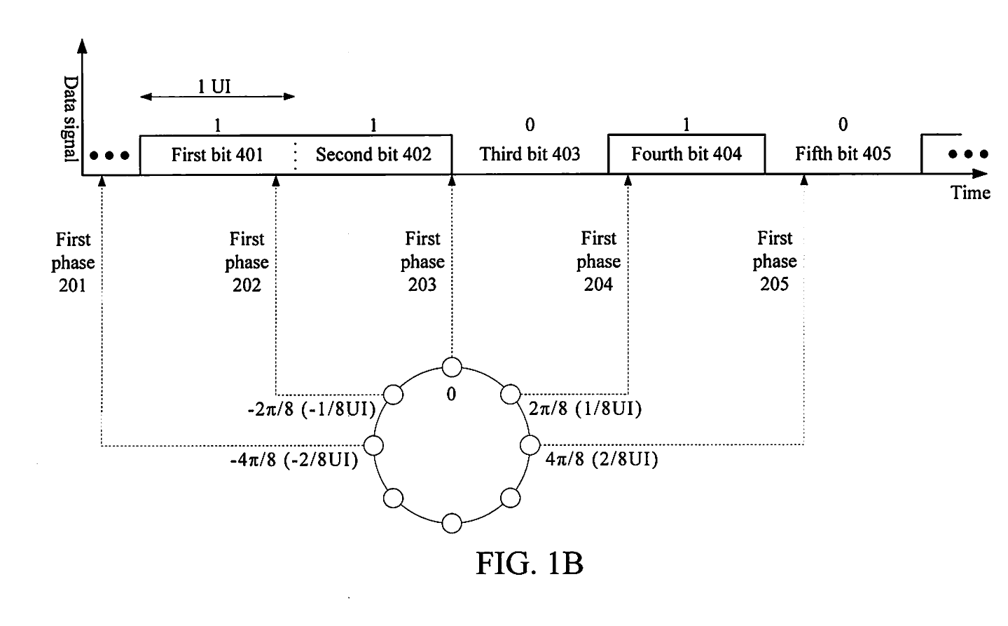

With reference to FIGS. 1A and 1B, a clock and data recovery device of the present invention will be elucidated in a first embodiment of the present invention. FIG. 1A is a schematic view of the clock and data recovery device 1 of this embodiment; while FIG. 1B is a schematic view illustrating signal sampling by the clock and data recovery device 1. As shown in FIG. 1A, the clock and data recovery device 1 comprises a sampler 11 and a processor 13. The sampler 11 comprises a phase generation circuit 111 and a first edge sampling circuit 113 electrically connected with the phase generation circuit 111. The clock and data recovery device 1 may be used in receiving terminals of various types of high-speed serial transmission systems to recover the data transmitted by transmitting terminals of the high-speed serial transmission systems.

The phase generation circuit 111 is configured to generate a plurality of first phases 20 which have different phase values. In this embodiment, the phase generation circuit 111 is a phase scanning circuit, which can generate the first phases 20 with different phase values through phase scanning at a specific frequency (e.g., 2.5 GHz). The first edge sampling circuit 113 can sample a plurality of first edge values 42 of a plurality of bits of a data signal 40 according to the first phases 20. The processor 13 is configured to determine a clock of the data signal 40 according to the first edge values 42 to accurately retrieve the data transmitted by a transmitting terminal from the data signal 40.

The processors 13 may be generally classified into analog processors and digital processors. Analog processors may include but is not limited to: a phase detector; a charge pump, a loop filter and a voltage control oscillator (VCO); and an analog processor is configured to perform analog signal processing, such as statistics, evaluation and calculation of the data sampled by the sampler 11 from the data signal 40 to determine the clock embedded in the data signal 40 and recover the data according to the determined clock.

Similarly, digital processors may include but is not limited to: a demultiplexer, a phase detector and a loop filter. A digital processor is configured to perform digital signal processing, such as statistics, evaluation and calculation of the data sampled by the sampler 11 from the data signal 40 to determine the clock embedded in the data signal 40 and recover the data according to the determined clock.

More specifically, the processor 13 mainly functions to perform processing such as statistics, evaluation and calculation on the data sampled by the sampler 11 from the data signal 40 in this embodiment. Accordingly, the present invention will not be affected by the different aspects of the processor 13. In other words, the normal operation of the present invention will not be substantially affected whether the various existing implementations or various implementations that can be readily devised in the future are adopted for the processor 13. Furthermore, the operations of the aforesaid elements (including analog and digital elements) comprised in the processor 13 can be readily appreciated by those of ordinary skill in the art, and thus, will not be further described herein.

The data signal 40 may comprise a plurality of bits. However, for convenience of description, only five of the bits will be described in this embodiment and are represented as the first bit 401, second bit 402, third bit 403, fourth bit 404 and fifth bit 405 respectively. Furthermore, data forms of the first bit 401, second bit 402, third bit 403, fourth bit 404 and fifth bit 405 are represented as 1, 1, 0, 1 and 0 respectively. The number of the bits or data forms of the bits described in this embodiment is only intended to explain but not to limit the present invention. Different numbers of the bits or different data forms of the bits can be readily devised by those of ordinary skill in the art according to the disclosure of this embodiment.

As shown in FIG. 1B, the data forms of the first bit 401, second bit 402, third bit 403, fourth bit 404 and fifth bit 405 are 1, 1, 0, 1 and 0 respectively, where each bit has a minimum resolution of 1/8 unit interval (UI). According to the aforesaid five bits, the phase generation circuit 111 can generate five corresponding first phases 20, which are represented by the first phase 201, second phase 202, third phase 203, fourth phase 204 and fifth phase 205 sequentially. In this case, through the processing of phase scanning, the first phase 201, second phase 202, third phase 203, fourth phase 204 and fifth phase 205 may have different phase values, for example, −4λ/8, −2π/8, 0, 2π/8 and 4π/8 in sequence, that correspond to the first bit 401, second bit 402, third bit 403, fourth bit 404 and fifth bit 405.

The first edge sampling circuit 113 determines the representation of the first phase 201, second phase 202, third phase 203, fourth phase 204 and fifth phase 205 in time sections according to these phases. For example, if the phase values of the first phase 201, second phase 202, third phase 203, fourth phase 204 and fifth phase 205 are −4π/8, −2π/8, 0, 2π/8 and 4π/8 respectively, then the sampling points (or sampling intervals) corresponding to the time sections are −2/8 UI, −1/8 UI, 0, 1/8 UI and 2/8 UI respectively. Next, the first edge sampling circuit 113 can perform edge sampling on the first bit 401, second bit 402, third bit 403, fourth bit 404 and fifth bit 405 of the data signal 40 sequentially according to the aforesaid sampling points (i.e., −2/8 UI, −1/8 UI, 0, 1/8 UI and 2/8 UI) to sample a plurality of first edge values 42.

The edge sampling described in this embodiment is performed on early edges of the bits; however, in other embodiments, the edge sampling may also be performed on late edges of the bits or on the early edges and the late edges of the bits alternately, but is not limited to the implementation described in this embodiment.

According to the aforesaid operations, the phases according to which the first edge sampling circuit 113 performs the edge sampling on the first bit 401, second bit 402, third bit 403, fourth bit 404 and fifth bit 405 are not fixed (i.e., the sampling points at which the edge sampling is performed on the bits that are not fixed), so the first edge values 42 sampled can cover a larger range. Because the first edge values 42 can provide more reference data for the processor 13, the processor 13 can determine the clock of the data signal 40 more accurately to properly retrieve the data transmitted by the transmitting terminal from the data signal 40.

It shall be appreciated that the minimum resolution of the UI and the phase values described in this embodiment are only intended to illustrate the present invention but not to limit the implementation of the present invention; that is, the minimum resolution of the UI and the phase values described in this embodiment may be adjusted or altered according to different implementations without affecting the normal operation of the present invention.

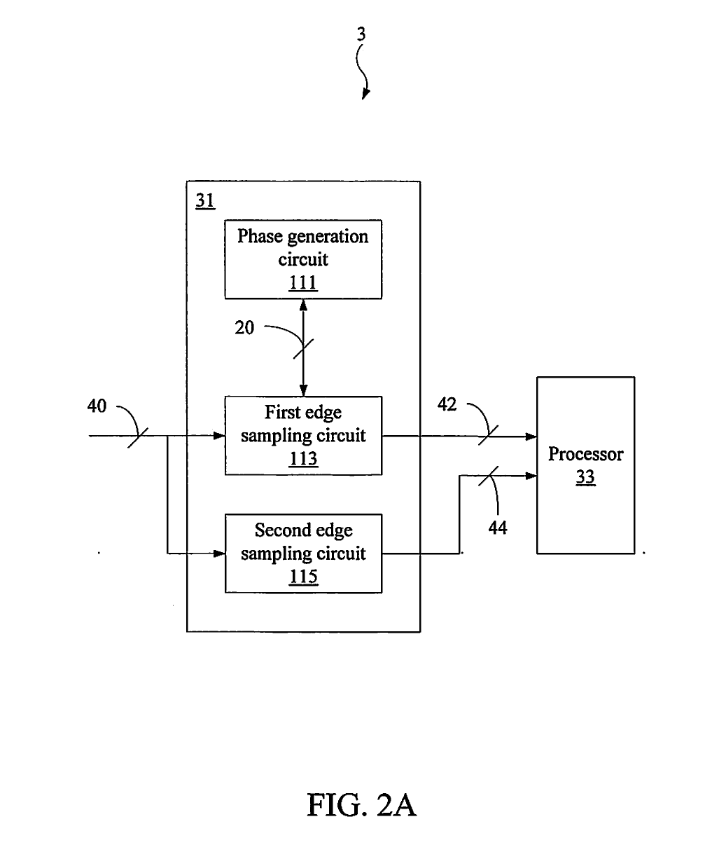

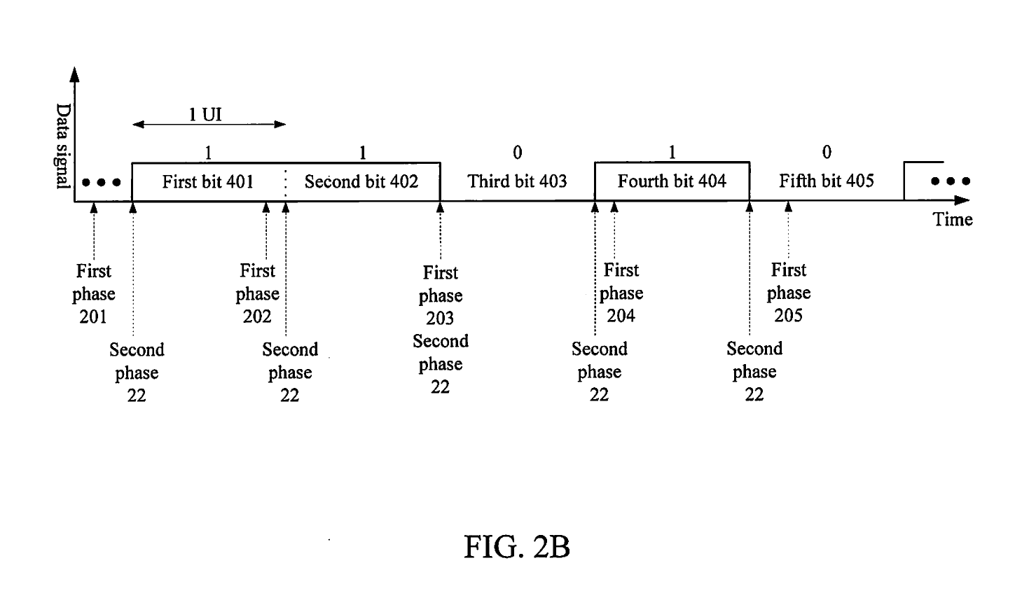

With reference to FIGS. 2A and 2B, a clock and data recovery device of the present invention will be elucidated in a second embodiment of the present invention. FIG. 2A is a schematic view of the clock and data recovery device 3 of this embodiment; while FIG. 2B is a schematic view illustrating the signal sampling by the clock and data recovery device 3. As shown in FIG. 2A, the clock and data recovery device 3 comprises a sampler 31 and a processor 33. The sampler 31 comprises a phase generation circuit 111, a first edge sampling circuit 113 electrically connected with the phase generation circuit 111, and a second edge sampling circuit 115. The clock and data recovery device 3 may be used in receiving terminals of various types of high-speed serial transmission systems to recover the data transmitted by transmitting terminals of the high-speed serial transmission systems.

Except for elements particularly described in this embodiment, all other elements can be understood as the corresponding elements in the aforesaid embodiment. The reference numerals of some of the elements described in the aforesaid embodiment will still be used in this embodiment to represent corresponding elements. Elements with the same reference numerals can be understood to represent substantially the same or similar elements. This embodiment will focus on only the technical contents different from those of the aforesaid embodiment, while the technical contents identical to the aforesaid embodiment will not be further described in this embodiment as they can be readily appreciated according to the aforesaid embodiment.

This embodiment differs from the first embodiment mainly in that the sampler 31 further comprises the second edge sampling circuit 115, which can be used to sample a plurality of second edge values 44 of the bits of the data signal 40 according to a second phase 22. On the other hand, the processor 33 can determine the clock of the data signal 40 according to the first edge values 42 and the second edge values 44 to properly retrieve the data transmitted by the transmitting terminal from the data signal 40.

The first edge sampling circuit 113 of this embodiment operates in the same way as that of the first embodiment, i.e., performs edge sampling on the data signal 40 (e.g., the first bit 401, second bit 402, third bit 403, fourth bit 404 and fifth bit 405) according to a plurality of first phases 20 (e.g., the first phase 201, second phase 202, third phase 203, fourth phase 204 and fifth phase 205) with different phase values. The second edge sampling circuit 115 performs edge sampling on the data signal 40 (e.g., the first bit 401, second bit 402, third bit 403, fourth bit 404 and fifth bit 405) according to a fixed phase value (i.e., the second phase 22).

As shown in FIG. 2B, the phase value of the second phase 22 is a fixed value and, for example, may be 0 or 16π/8 (i.e., the zero phase). In this case, the second edge sampling circuit 115 can determine that the sampling point (or the sampling interval) of the second phase 22 corresponding to the time section should be 1 UI. Then, the second edge sampling circuit 115 can sample the second edge values 44 by performing edge sampling on the first bit 401, the second bit 402, the third bit 403, the fourth bit 404 and the fifth bit 405 of the data signal 40 sequentially according to the fixed sampling point (i.e., 1 UI).

The phase value of the second phase 22 described in this embodiment is only intended to illustrate the present invention but not to limit the implementation of the present invention; that is, the phase value of the second phase 22 described in this embodiment may be adjusted or altered according to different implementations without affecting the normal operation of the present invention.

According to the aforesaid operations, the sampler 31 can perform the edge sampling on the bits of the data signal 40 according to both the fixed phase and the unfixed phases. Because the data sampled by the sampler 31 covers a larger range, the processor 33 can get more data for reference when determining the clock embedded in the data signal 40. In other words, the processor 33 can determine the clock of the data signal 40 more accurately to properly retrieve the data transmitted by the transmitting terminal from the data signal 40.

In addition to the aforesaid operations, the clock and data recovery device 3 of this embodiment can also execute all the operations set forth in the aforesaid embodiment and deliver the corresponding functions. The method in which the clock and data recovery device 3 of this embodiment executes these operations and implements these functions can be readily appreciated by those of ordinary skill in the art based on the disclosure of the aforesaid embodiment, and thus, will not be further described herein.

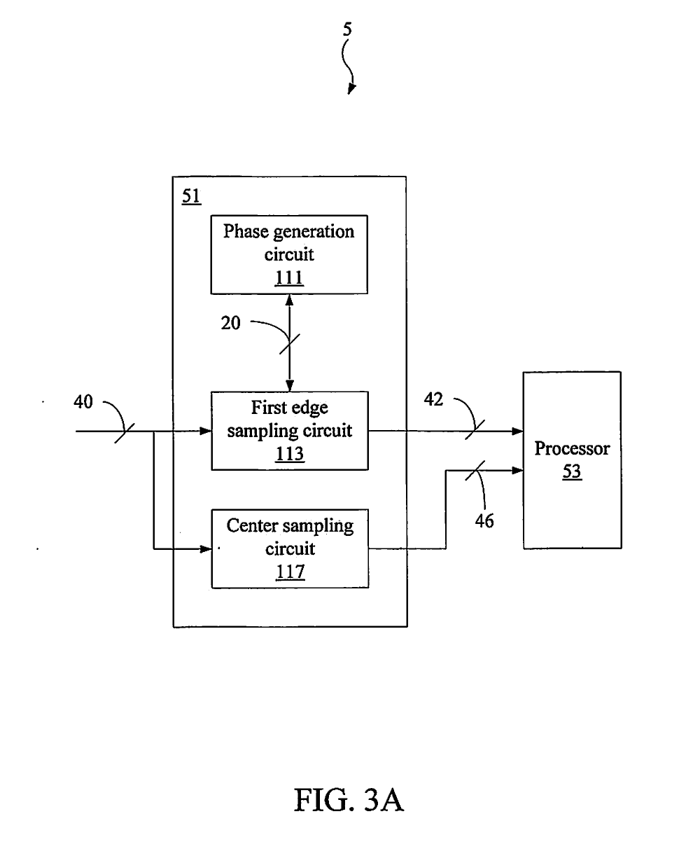

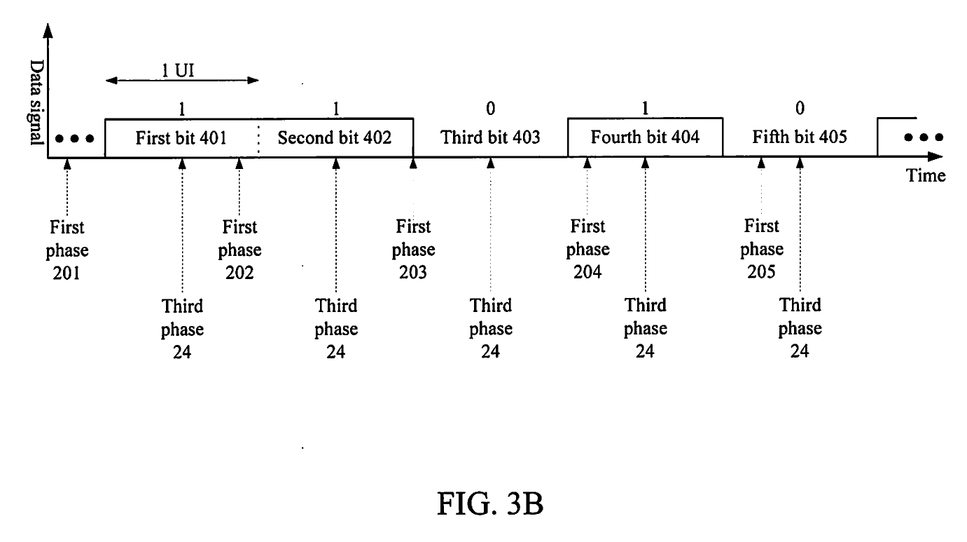

With referring to FIGS. 3A and 3B, the clock and data recovery device of the present invention will be elucidated in a third embodiment of the present invention. FIG. 3A is a schematic view of the clock and data recovery device 5 of this embodiment; while FIG. 3B is a schematic view illustrating signal sampling by the clock and data recovery device 5. As shown in FIG. 3A, the clock and data recovery device 5 comprises a sampler 51 and a processor 53. The sampler 51 comprises a phase generation circuit 111, a first edge sampling circuit 113 electrically connected with the phase generation circuit 111, and a center sampling circuit 117. The clock and data recovery device 5 may be used in receiving terminals of various types of high-speed serial transmission systems to recover the data transmitted by transmitting terminals of the high-speed serial transmission systems.

Except for elements particularly described in this embodiment, all other elements can be understood as the corresponding elements in the aforesaid embodiments, and the reference numerals of some of the elements described in the aforesaid embodiments will still be used in this embodiment to represent corresponding elements. Elements with the same reference numerals can be understood to represent substantially the same or similar elements. This embodiment will focus on only the technical contents different from those of the aforesaid embodiments, while the technical contents identical to the aforesaid embodiments will not be further described in this embodiment as they can be readily appreciated according to the aforesaid embodiments.

Under the 2× over-sampling structure, the clock and data recovery device samples each bit (or each UI) twice. Specifically, during the first time, the data center of each bit is sampled, while during the second time, the data edge bit is sampled. Here, the data center sampling refers to sampling the right center of each bit comprised in the received signal.

Unlike the clock and data recovery device 1 of the first embodiment, the sampler 51 further comprises the center sampling circuit 117, which can be used to sample a plurality of center values 46 of the bits of the data signal 40 according to a third phase 24. On the other hand, the processor 53 can determine the clock of the data signal 40 according to the first edge values 42 and the center values 46 to properly retrieve the data transmitted by the transmitting terminal from the data signal 40.

The first edge sampling circuit 113 of this embodiment operates in the same way as that of the first embodiment, i.e., performs edge sampling on the data signal 40 (e.g., the first bit 401, second bit 402, third bit 403, fourth bit 404 and fifth bit 405) according to a plurality of first phases 20 (e.g., the first phase 201, second phase 202, third phase 203, fourth phase 204 and fifth phase 205) with different phase values. On the other hand, the center sampling circuit 117 samples the data signal 40 (e.g., respective data center points of the first bit 401, second bit 402, third bit 403, fourth bit 404 and fifth bit 405) according to a fixed phase value (i.e., the third phase 24).

As shown in FIG. 3B, the phase value of the third phase 24 is a fixed value and, for example, may be π. In this case, the center sampling circuit 117 can determine that the sampling point (or the sampling interval) of the third phase 24 corresponding to the time section should be 4/8 UI. Then, the center sampling circuit 117 can sample the respective data center points of the first bit 401, second bit 402, third bit 403, fourth bit 404 and fifth bit 405 of the data signal 40 sequentially according to the aforesaid sampling point (i.e., 4/8 UI) to get the center values 46.

The phase value of the third phase 24 described in this embodiment is only intended to illustrate the present invention but not to limit the implementation of the present invention; that is, the phase value of the third phase 24 described in this embodiment may be adjusted or altered according to different implementations without affecting the normal operation of the present invention. Moreover, the method in which the center sampling circuit 117 samples the data center points of the bits comprised in the data signal 40 is not merely limited to what has been described in this embodiment, and other implementations of the center sampling circuit 117 can be appreciated by those of ordinary skill in the art and, thus, will not be further described herein.

Unlike the conventional 2× over-sampling structure, the phases according to which the first edge sampling circuit 113 of this embodiment performs the edge sampling of the first bit 401, second bit 402, third bit 403, fourth bit 404 and fifth bit 405 are not fixed (i.e., the sampling points at which the edge sampling is performed on the bits are not fixed), so the first edge values 42 sampled can cover a larger range. Because the first edge values 42 can provide wider reference data for the processor 13, the processor 13 can determine the clock of the data signal 40 more accurately to properly retrieve the data transmitted by the transmitting terminal from the data signal 40. Accordingly, the clock and data recovery device 5 of this embodiment can easily achieve a 2× over-sampling structure and has better performances.

In addition to the aforesaid operations, the clock and data recovery device 5 of this embodiment can also execute all the operations set forth in the aforesaid embodiments and deliver the corresponding functions. The method in which the clock and data recovery device 5 of this embodiment executes these operations and implements these functions can be readily appreciated by those of ordinary skill in the art based on the disclosure of the aforesaid embodiments, and thus, will not be further described herein.

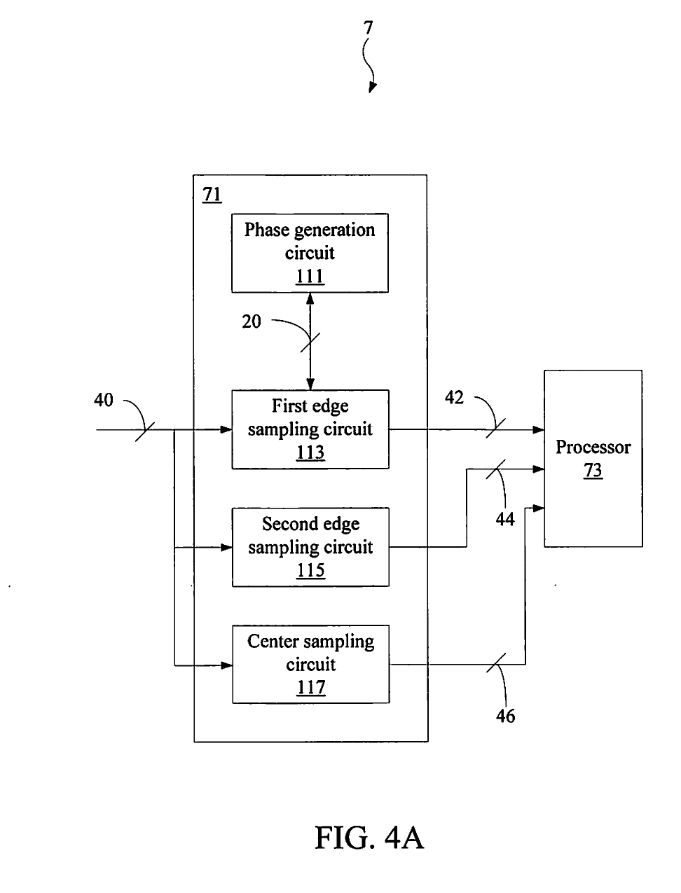

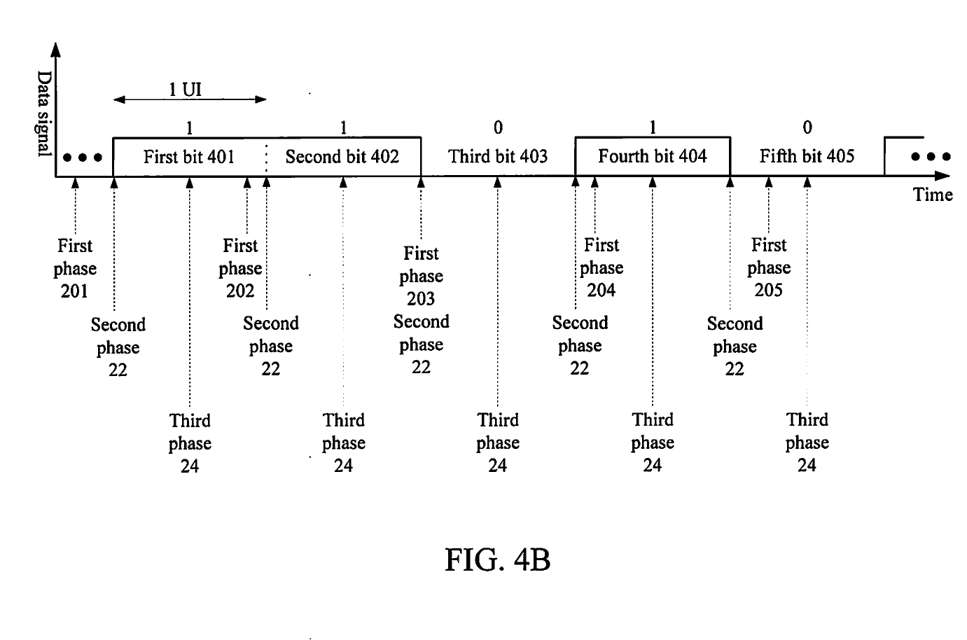

With reference to FIGS. 4A and 4B, a clock and data recovery device of the present invention will be elucidated in a fourth embodiment of the present invention. FIG. 4A is a schematic view of the clock and data recovery device 7 of this embodiment; while FIG. 4B is a schematic view illustrating signal sampling by the clock and data recovery device 7. As shown in FIG. 4A, the clock and data recovery device 7 comprises a sampler 71 and a processor 73, while the sampler 71 comprises a phase generation circuit 111, a first edge sampling circuit 113 electrically connected with the phase generation circuit 111, a second edge sampling circuit 115 and a center sampling circuit 117. The clock and data recovery device 7 may be used in receiving terminals of various types of high-speed serial transmission systems to recover the data transmitted by transmitting terminals of the high-speed serial transmission systems.

Except for elements particularly described in this embodiment, all other elements can be understood as the corresponding elements in the aforesaid embodiments, and the reference numerals of some of the elements described in the aforesaid embodiments will still be used in this embodiment to represent corresponding elements. Elements with the same reference numerals can be understood to represent substantially the same or similar elements. This embodiment will focus on only the technical contents different from those of the aforesaid embodiments, while the technical contents identical to the aforesaid embodiments will not be further described in this embodiment as they can be readily appreciated according to the aforesaid embodiments.

This embodiment differs from the aforesaid embodiments mainly in that the sampler 31 further comprises both the second edge sampling circuit 115 and the center sampling circuit 117 in addition to the phase generation circuit 111 and the first edge sampling circuit 113. Identical to what has been described in the second embodiment, the second edge sampling circuit 115 of this embodiment can be used to sample a plurality of second edge values 44 of the bits of the data signal 40 according to the second phase 22. In addition, similar to what has been described in the third embodiment; the center sampling circuit 117 of this embodiment can be used to sample a plurality of center values 46 of the bits of the data signal 40 according to the third phase 24. On the other hand, the processor 73 can determine the clock of the data signal 40 according to the first edge values 42, the second edge values 44 and the center values 46 to properly retrieve the data transmitted by the transmitting terminal from the data signal 40.

Furthermore, the operations and functions of each of the second edge sampling circuit 115 and the center sampling circuit 117 of this embodiment are substantially the same as those described in the second embodiment and the third embodiment. Therefore, the method in which the clock and data recovery device 7 of this embodiment operates can be readily appreciated by those of ordinary skill in the art based on the disclosure of the second embodiment and the third embodiment and, thus, will not be further described herein.

In addition to the aforesaid operations, the clock and data recovery device 7 of this embodiment can also execute all the operations set forth in the aforesaid embodiments and deliver the corresponding functions. The method in which the clock and data recovery device 7 of this embodiment executes these operations and implements these functions can be readily appreciated by those of ordinary skill in the art based on the disclosure of the aforesaid embodiments, and thus, will not be further described herein.

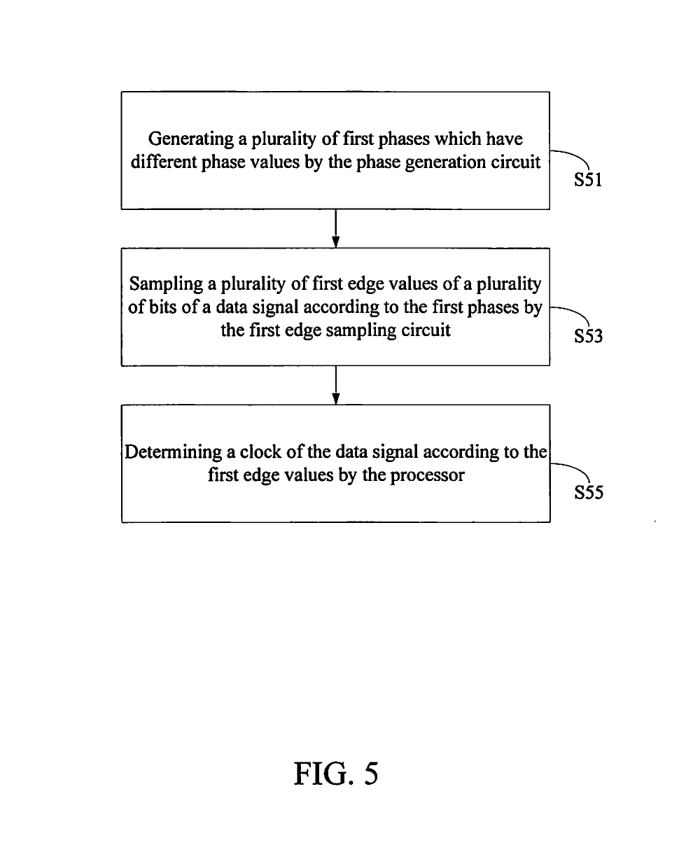

With reference to FIG. 5, a sampling method for use in a clock and data recovery device of the present invention will be elucidated in a fifth embodiment of the present invention. FIG. 5 is a flowchart diagram of the sampling method of this embodiment. The sampling method of this embodiment may be used in the clock and data recovery devices (i.e., the clock and data recovery device 1, the clock and data recovery device 3, the clock and data recovery device 5 and the clock and data recovery device 7) disclosed in the aforesaid embodiments. Therefore, the clock and data recovery device of this embodiment may comprise a sampler and a processor, while the sampler may comprise a phase generation circuit and a first edge sampling circuit electrically connected with the phase generation circuit.

As shown in FIG. 5, step S51 is executed to generate a plurality of first phases which have different phase values by the phase generation circuit; step S53 is executed to sample a plurality of first edge values of a plurality of bits of a data signal according to the first phases by the first edge sampling circuit; and step S55 is executed to determine a clock of the data signal according to the first edge values by the processor.

When the sampling method of this embodiment is used in the clock and data recovery device 3 disclosed in the second embodiment, the sampling method of this embodiment further comprises a step S57 of sampling a plurality of second edge values of the bits of the data signal according to a second phase by a second edge sampling circuit of the sampler. In this case, step S55 is a step S551 of determining the clock of the data signal according to the first edge values and the second edge values by the processor.

When the sampling method of this embodiment is used in the clock and data recovery device 5 disclosed in the third embodiment, the sampling method of this embodiment further comprises a step S59 of sampling a plurality of center values of the bits of the data signal according to a third phase by a center sampling circuit of the sampler. In this case, step S55 is a step S553 of determining the clock of the data signal according to the first edge values and the center values by the processor.

When the sampling method of this embodiment is used in the clock and data recovery device 7 disclosed in the fourth embodiment, the sampling method of this embodiment further comprises step S57 and step S59. In this case, step S55 is a step S555 of determining the clock of the data signal according to the first edge values, the second edge values and the center values by the processor.

In addition to the aforesaid steps, the sampling method of the fifth embodiment can also execute all the operations set forth in the aforesaid embodiments and deliver the corresponding functions. The method in which the sampling method of this embodiment executes these operations and implements these functions can be readily appreciated by those of ordinary skill in the art based on the disclosure of the aforesaid embodiments, and thus, will not be further described herein.

According to the above descriptions, the present invention provides a clock and data recovery device, a sampler and a sampling method thereof. Unlike the conventional CDR interface, the clock and data recovery device, the sampler and the sampling method thereof according to the present invention generate a plurality of different phases through phase scanning and sample edges of a plurality of bits of a data signal respectively according to the phases with different phase values.

As the sampling is performed through phase scanning, the sampling point will not be fixed anymore, and the edge values sampled from the edges of the bits of the data signal can cover a wider range. Therefore, the edge positions of the bits of the data signal can be estimated more rapidly and accurately to determine the proper clock embedded in the data signal. Accordingly, the clock and data recovery device, the sampler and the sampling method thereof according to the present invention have effectively improved the sampling accuracy and also increased the jitter tolerance of the receiving terminal.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A sampler for use in a clock and data recovery device, comprising:
a phase generation circuit, being configured to generate a plurality of first phases which have different phase values; and
a first edge sample circuit, being electrically connected with the phase generation circuit and configured to sample a plurality of first edge values of a plurality of bits of a data signal according to the first phases so that the clock and data recovery device determines a clock of the data signal according to the first edge values.

2. The sampler as claimed in claim 1, further comprising a second edge sampling circuit configured to sample a plurality of second edge values of the bits of the data signal according to a second phase so that the clock and data recovery device determines the clock of the data signal according to the first edge values and the second edge values.

3. The sampler as claimed in claim 1, further comprising a center sampling circuit configured to sample a plurality of center values of the bits of the data signal according to a third phase so that the clock and data recovery device determines the clock of the data signal according to the first edge values and the center values.

4. The sampler as claimed in claim 2, further comprising a center sampling circuit configured to sample a plurality of center values of the bits of the data signal according to a third phase so that the clock and data recovery device determines the clock of the data signal according to the first edge values, the second edge values and the center values.

5. A clock and data recovery device, comprising:
a sampler, comprising:
a phase generation circuit, being configured to generate a plurality of first phases which have different phase values; and
a first edge sampling circuit, being electrically connected with the phase generation circuit and configured to sample a plurality of first edge values of a plurality of bits of a data signal according to the first phases; and
a processor, being configured to determine a clock of the data signal according to the first edge values.

6. The clock and data recovery device as claimed in claim 5, wherein the sampler further comprises a second edge sampling circuit configured to sample a plurality of second edge values of the bits of the data signal according to a second phase, and the processor determines the clock of the data signal according to the first edge values and the second edge values.

7. The clock and data recovery device as claimed in claim 5, wherein the sampler further comprises a center sampling circuit configured to sample a plurality of center values of the bits of the data signal according to a third phase, and the processor determines the clock of the data signal according to the first edge values and the center values.

8. The clock and data recovery device as claimed in claim 6, wherein the sampler further comprises a center sampling circuit configured to sample a plurality of center values of the bits of the data signal according to a third phase, and the processor determines the clock of the data signal according to the first edge values, the second edge values and the center values.

9. A sampling method for use in a clock and data recovery device, the clock and data recovery device comprising a sampler and a processor, the sampler comprising a phase generation circuit and a first edge sampling circuit electrically connected with the phase generation circuit, the sampling method comprising the following steps:
(a) generating a plurality of first phases which have different phase values by the phase generation circuit;
(b) sampling a plurality of first edge values of a plurality of bits of a data signal according to the first phases by the first edge sampling circuit; and
(c) determining a clock of the data signal according to the first edge values by the processor.

10. The sampling method as claimed in claim 9, further comprising the following step:
(d) sampling a plurality of second edge values of the bits of the data signal according to a second phase by a second edge sampling circuit of the sampler;
wherein the step (c) is a step of:
(c1) determining the clock of the data signal according to the first edge values and the second edge values by the processor.

11. The sampling method as claimed in claim 9, further comprising the following step:
(e) sampling a plurality of center values of the bits of the data signal according to a third phase by a center sampling circuit of the sampler;
wherein the step (c) is a step of:
(c2) determining the clock of the data signal according to the first edge values and the center values by the processor.

12. The sampling method as claimed in claim 10, further comprising the following step:
(e) sampling a plurality of center values of the bits of the data signal according to a third phase by a center sampling circuit of the sampler;
wherein the step (c1) is a step of:
(c3) determining the clock of the data signal according to the first edge values, the second edge values and the center values by the processor.
